(19) United States
(12) Patent Application Publication
(10) Pub. No.: US 2014/0068150 A1
(43) Pub. Date: Mar. 6, 2014

(54) DATA STORAGE DEVICE AND OPERATING METHOD THEREOF

(71) Applicant: SK HYNIX INC., Icheon-si (KR)

(72) Inventors: Ho Jung YUN, Icheon-si (KR); Young Soo PARK, Icheon-si (KR)

(73) Assignee: SK HYNIX INC., Icheon-si (KR)

(21) Appl. No.: 13/778,284

(22) Filed: Feb. 27, 2013

(30) Foreign Application Priority Data
Sep. 4, 2012 (KR) 10-2012-0097785

(51) Int. Cl. G06F 3/06

(52) U.S. Cl. CPC G06F 3/0688
USPC 711/103; 711/154

(57) ABSTRACT

A data storage device includes: a first memory device. a second memory device configured to share a write control signal and a read control signal which are provided to the first memory device. and a controller configured to control the first and second memory devices, wherein the controller provides the write control signal and the read control signal to the first and second memory devices at the same time, the first memory device receives only the read control signal according to a first mask signal, and the second memory device receives only the write control signal according to a second mask signal.

### CROSS-REFERENCES TO RELATED APPLICATION

The present application claims priority under 35 U.S.C. §119(a) to Korean application number 10-2012-0097785, filed on Sep. 4, 2012, in the Korean Intellectual Property Office, which is incorporated herein by reference in its entirety.

### BACKGROUND

1. Technical Field

The present invention relates generally to a data storage device, and more particularly, to a data storage device including a plurality of memory devices and an operating method thereof.

2. Related Art

Recently, the paradigm of the computing environment has changed and has become more ubiquitous in which computer systems are used anytime and anywhere. Accordingly, the use of portable electronic devices such as mobile phones, digital cameras, and notebook computers has rapidly increased. Generally, such a portable electronic device uses a data storage device that contains a plurality of memory devices. The data storage device is used as a main memory device or secondary memory device of the portable electronic device.

The data storage device that contains a plurality of memory devices includes no mechanical driver. Thus, the data storage device has excellent stability and durability, exhibits high information access speed, and has small power consumption. Examples of a data storage device having such advantages may include a USB (Universal Serial Bus) memory device, a memory card having various interfaces, a solid state drive (SSD) and the like.

As more portable electronic devices have the capability to reproduce large files such as music files and video files, the data storage device is required to have a large storage capacity. The data storage device includes a plurality of memory devices to handle the increase in storage capacity. The plurality of memory devices may share a control signal bus for receiving control signals from a memory controller, and may also share a data bus for receiving data to program from the memory controller and providing data stored therein. In such a data storage device, data transmission between is the respective memory devices (for example, transferring, copying or the like) is performed through a process of reading data to transmit from a source memory device through the memory controller and storing the read data in a target memory device. In other words, data is transmitted between the respective memory devices under the control of the memory controller.

### SUMMARY

A data storage device capable of directly transmitting data between memory devices and an operating method thereof are described herein.

In an embodiment of the present invention, a data storage device includes: a first memory device, a second memory device configured to share a write control signal and a read control signal which are provided to the first memory device, and a controller configured to control the first and second memory devices, wherein the controller provides the write control signal and the read control signal to the first and second memory devices at the same time. The first memory device receives only the read control signal according to a first mask signal, and the second memory device receives only the write control signal according to a second mask signal.

In another embodiment of the present invention, an operating method of a data storage device including a plurality of memory devices includes the steps of: applying a write control signal and a read control signal to both the first and second memory devices at the same time, applying a first mask signal to the first memory device so as to control the first memory device to receive only the read control signal between the write control signal and the read control signal which are applied at the same time, applying a second mask signal to the second memory device so as to control the second memory device to receive only the write control signal between the write control signal and the read control signal which are applied at the same time, and controlling the first and second memory devices at the same time such that the first memory device outputs data while the first mask signal is applied and the second memory device receives data outputted from the first memory device while the second mask signal is applied.

### BRIEF DESCRIPTION OF THE DRAWINGS

Features, aspects, and embodiments are described in conjunction with the attached drawings, in which:

FIG. 1 is a perspective view illustrating a plurality of memory devices included in a data storage device according to an embodiment of the present invention;

FIG. 2 is a table illustrating control signals applied to the memory devices and mask signals for masking the control signals, while data is directly being transmitted among the memory devices illustrated in FIG. 1;

FIG. 3 is a perspective view illustrating a plurality of memory devices included in a data storage device according to another embodiment of the present invention;

FIG. 4 is a table illustrating control signals applied to the memory devices and mask signals for masking the control signals, while data is directly being transmitted between the respective memory devices illustrated in FIG. 3;

FIGS. 5 and 6 are timing diagrams illustrating a data transmission method of the data storage device according to an embodiment of the present invention;

FIG. 7 is a block diagram illustrating a data processing system including the nonvolatile memory device according to an embodiment of the present invention;

FIG. 8 is a block diagram illustrating an SSD configured to perform the data transmission method according to an embodiment of the present invention;

FIG. 9 is a block diagram illustrating an SSD controller of FIG. 8; and

FIG. 10 is a block diagram illustrating a computer system in which the data storage device according to an embodiment of the present invention is mounted.

### DETAILED DESCRIPTION

Hereinafter, a data storage device and an operating method thereof according to the present invention will be described below with reference to the accompanying drawings through various embodiments.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

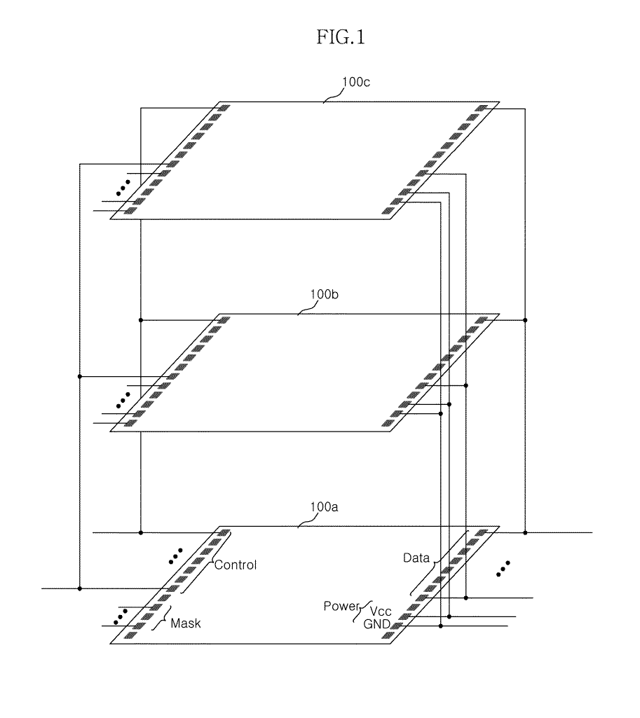

FIG. 1 is a perspective view illustrating a plurality of memory devices included in a data storage device according to an embodiment of the present invention. Referring to FIG. 1, the data storage device includes a plurality of memory devices 100a, 100b, and 100c. For convenience of description, suppose that the data storage device includes three memory devices 100a, 100b, and 100c. However, the number of memory devices included in the data storage device is not limited to three in the presently claimed invention, and may differ depending on the storage capacity of the data storage device.

The memory devices 100a, 100b, and 100c include pins (or pads) that serve to interconnect the multiple memory devices. Mask pins (or pads) serve a different purpose of applying mask signals. Since pins interconnect the multiple memory devices, the memory devices 100a, 100b, and 100c may share control signals and data provided from an external device such as a memory controller, a host device or the like. In other words, when a source memory device to provide data and a target memory device to receive data are set among the memory devices 100a, 100b, and 100c, data shared in a data bus may be transmitted between the memory devices.

The control signals provided to the memory devices 100a, 100b, and 100c may include a chip enable signal (or chip select signal), a write control signal, and a read control signal for controlling the operations of the memory devices 100a, 100b, and 100c. Further, the control signals may include a command and address for controlling the operations of the memory devices 100a, 100b, and 100c. For example, the command and address may be provided to the memory devices 100a, 100b, and 100c through control signal pins. As another example, the command and address may be provided through data pins according to an input/output multiplexing method. That is, the command and address may be provided through the data pins, and the type of a signal provided through the data pins, whether the signal is a command, address, or data, may be determined according to control signals provided through control signal pads.

The type of the control signals may differ depending on the type of the memory devices 100a, 100b, and 100c. A method (or scheme) for providing the control signals may also differ depending on the type of the memory devices 100a, 100b, and 100c.

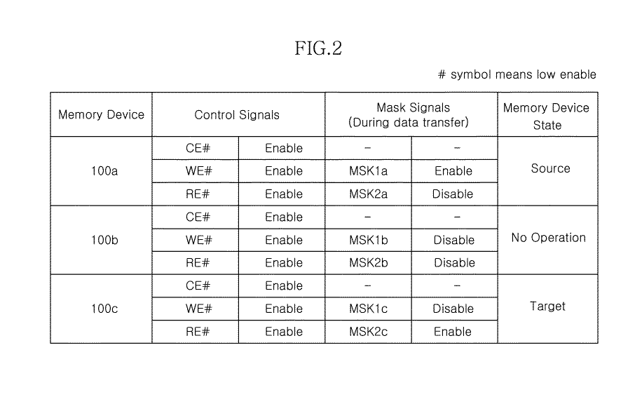

According to an embodiment of the present invention, different mask signals may be provided to the respective memory devices 100a, 100b, and 100c so as to selectively provide control signals shared among the memory devices 100a, 100b, and 100c to the memory devices 100a, 100b, and 100c. When the control signals are selectively provided to the memory devices 100a, 100b, and 100c according to the mask signals, a memory device may operate as a source memory device, and another memory device may operate as a target memory device. Since the source memory device and the target memory device can share data through data pins connected to each other, data transmission therebetween may be directly performed without intervention of a memory controller. That is, data outputted from the source memory device may be directly transmitted to the target memory device without passing through the memory controller. The method for selectively providing control signals to the memory devices 100a, 100b, and 100c according to mask signals will be described in detail with reference to FIG. 2.

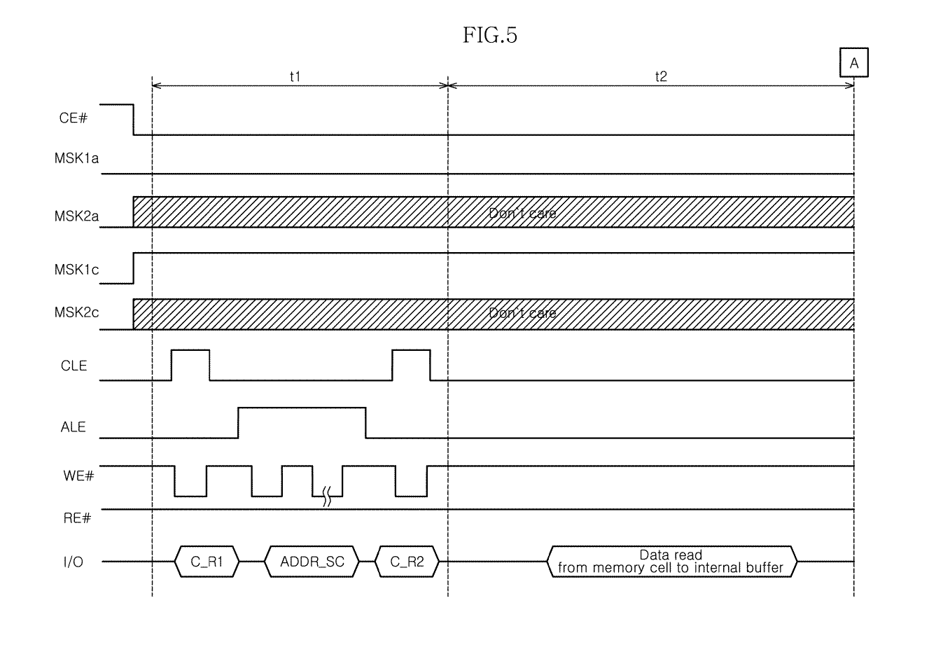

FIG. 2 is a table illustrating control signals applied to the memory devices and mask signals for masking the control signals, while data is being directly transmitted among the memory devices illustrated in FIG. 1. In FIG. 2, suppose that the memory device 100a is set to a source memory device to provide data and the memory device 100c is set to a target memory device to receive data, through a series of processes. The series of processes of setting the memory devices 100a and 100c sharing the control signals to the source and target memory devices, respectively, will be described with reference to FIG. 5.

As described above, the memory devices 100a, 100b, and 100c may use the input/output multiplexing method. That is, the memory devices 100a, 100b, and 100c may receive a command and address as well as data through data input/output pins (or pads). In order to use the input/output multiplexing method, the memory devices 100a, 100b, and 100c may determine which signal is applied to data input/output pins, through a combination of provided control signals.

For example, the control signals may include a command latch enable signal CLE, an address latch enable signal ALE, a write enable signal WE, and a read enable signal RE. Such control signals are used only to describe an embodiment of the present invention, and may differ depending on the type of the memory devices 100a, 100b, and 100c.

The command latch enable signal CLE is a signal which is provided to the memory devices 100a, 100b, and 100c in order to announce that a signal inputted through the data input/output pins is a command. The address latch enable signal ALE is a signal which is provided to the memory devices 100a, 100b, and 100c in order to announce that a signal inputted through the data input/output pins is an address. The write enable signal WE is a signal which is provided to the memory devices 100a, 100b, and 100c in order to input a command, address, or data through the data input/output pins. The read enable signal RE is a signal which is provided to the memory devices 100a, 100b, and 100c in order to control data read from memory cells to be outputted externally.

After the memory device 100a is set to a source memory device and the memory device 100c is set to a target memory device through the series of processes, data transmission between the source memory device 100a and the target memory device 100c is substantially performed through the shared data pins. The source memory device 100a then outputs data read from memory cells externally through the data pins according to the read enable signal RE. Then, the target memory device 100c receives the data provided through the shared data pins according to the write enable signal WE.

During the data transmission operation, the write enable signal WE as well as the read enable signal RE required for outputting data may be provided to the source memory device 100a, and the read enable signal RE as well as the write enable signal WE required for receiving data may be provided to the target memory device 100c. That is, since the control signal pins of the source memory device 100a and the target memory device 100c are connected to each other, control signals which are not required for the operation may be provided to the source memory device 100a and the target memory is device 100c.

According to an embodiment of the present invention, an activated mask signal MSK1a for masking the write enable signal WE is provided to the source memory device 100a so as to provide only the read enable signal RE to the source memory device 100a during the data transmission operation. Further, an activated mask signal MSK2c for masking the read enable signal RE is provided to the target memory device 100c so as to provide only the write enable signal WE to the target memory device 100c. Further, activated mask signals MSK1b and MSK2b are provided to the memory device 100b so as not to provide both of the read enable signal RE and the write enable signal WE to the memory device 100b. That is, in order to selectively provide the control signals, the mask signals are provided to the source memory device and the target memory device which share the control signals.

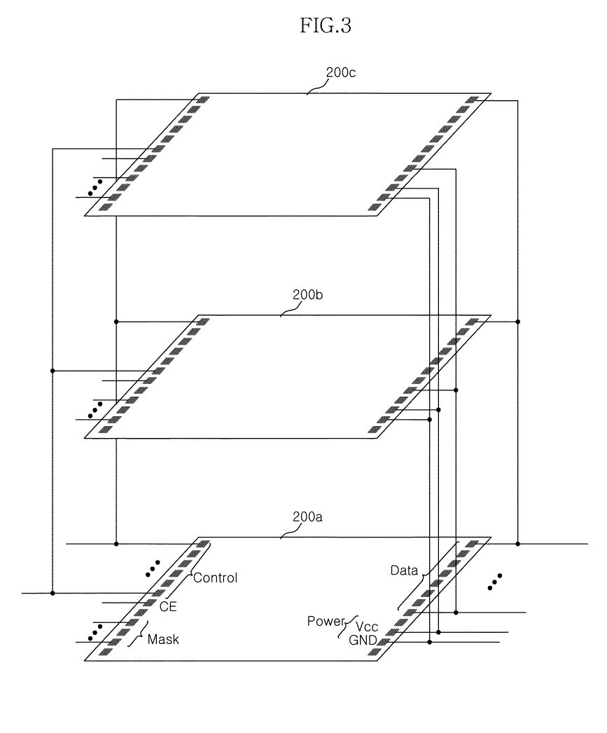

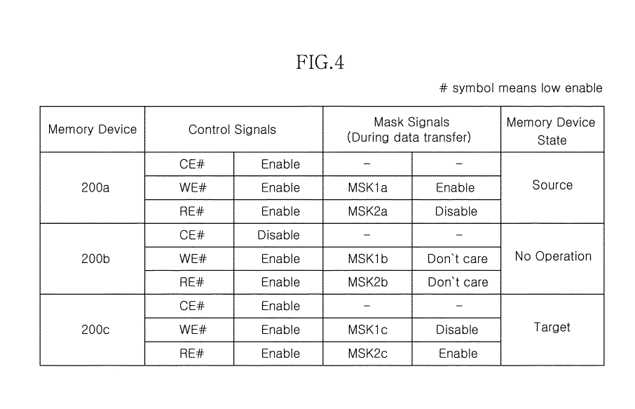

FIG. 3 is a perspective view illustrating a plurality of memory devices included in a data storage device according to another embodiment of the present invention. FIG. 4 is a table for illustrating control signals applied to the memory devices and mask signals for masking the control signals, while data is being directly transmitted between the respective memory devices illustrated in FIG. 3.

Referring to FIG. 3, the data storage device includes a plurality of memory devices 200a, 200b, and 200c. For convenience of description, FIG. 3 illustrates that the data storage device includes is three memory devices 200a, 200b, and 200c. However, the number of memory devices included in the data storage device is not limited to three in the presently claimed invention, and may differ depending on the storage capacity of the data storage device.

The memory devices 200a, 200b, and 200c include pins (or pads) that serve to interconnect the multiple memory devices. Mask pins (or pads) serve a different purpose of applying mask signals. Chip enable pins serve to apply a chip enable signal (or chip enable signal). Similar to how all the controls pins of the memory devices 100a, 100b, and 100c of FIG. 1 except for the mask pins are connected to each other, all the control pins of the memory devices 200a, 200b, and 200c of FIG. 2 except for the mask pins and the chip enable pins are connected to each other.

Referring to FIG. 4, since a chip enable signal CE is not provided to the memory device 200b, the memory device 200b does not operate. Therefore, any one of the memory devices 200a and 200c operates as a source memory device, and the other one operates as a target memory device. Except when the source memory device and the target memory device are set among the memory devices 200a, 200b, and 200c according to the chip enable signal CE, a method for selectively providing the control signals to the source memory device and the target memory device according to the mask signals is performed in a substantially similar manner as described with reference to FIG. 2. Therefore, the detailed descriptions thereof are omitted herein.

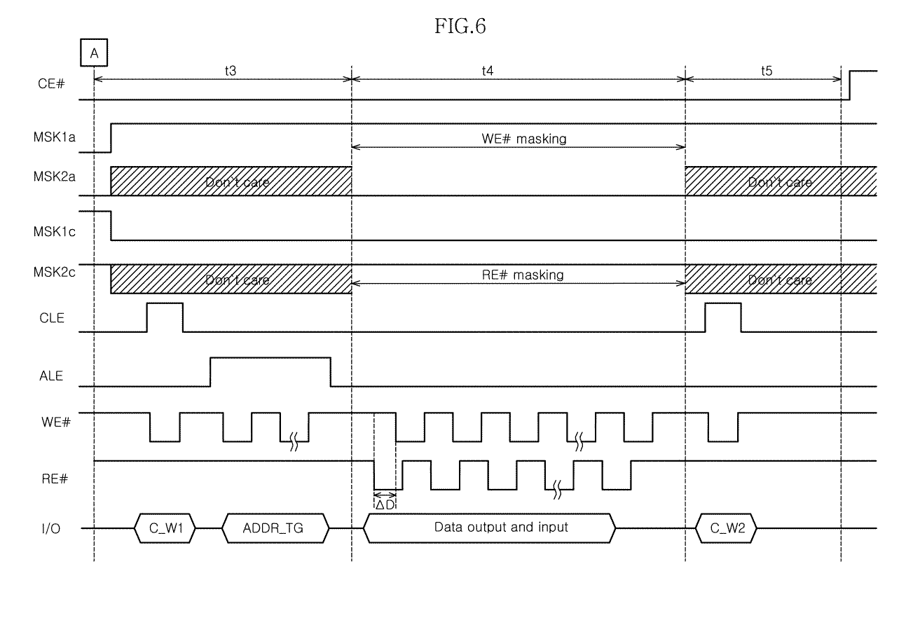

FIGS. 5 and 6 are timing diagrams illustrating the data transmission method of the data storage device according to an embodiment of the present invention. FIGS. 5 and 6 illustrate the process of setting a source memory device and a target memory device among the memory devices sharing the chip enable signal CE (that is, the memory devices 100a, 100b, and 100c of FIG. 1) and the process of controlling data to be directly transmitted between the source memory device and the target memory device.

During a time t1, the memory device 100a is set to a source memory device. For example, the command latch enable signal CLE and the write enable signal WE are activated to provide read commands C_R1 and C_R2 to the memory device 100a, and the address latch enable signal ALE and the write enable signal WE are activated to provide a source address ADDR_SC to the memory device 100a. Although the control signals are shared by the memory devices 100a, 100b, and 100c through the connection among the control signal pins, only the memory device 100a may receive the commands and address, because activated mask signals for masking the write enable signal (FIG. 5 shows only the mask signal MSK1c) are provided to the respective memory devices 100b and 100c. The memory device 100a is set to the source memory device according to the provided read commands C_R1 and C_R2 and the address ADDR_SC where source data is positioned.

During a time t2, the source memory device 100a reads data stored in memory cells. For example, the source memory device 100a may determine data to be stored in the memory cells, and store the determination result in an internal buffer circuit.

During a time t3, the memory device 100c is set to a target memory device. For example, the command latch enable signal CLE and the write enable signal WE are activated to provide a write command C_W1 to the memory device 100c, and the address latch enable signal ALE and the write enable signal WE are activated to provide a target address ADDR_TG to the memory device 100c. Although the control signals are shared by the memory devices 100a, 100b, and 100c through the connection among the control signal pins, only the memory device 100c may receive the command and address, because activated mask signals for masking the write enable signal (FIG. 6 shows only the mask signal MSK1a) are provided to the respective memory devices 100a and 100b. The memory device 100c is set to the target memory device according to the provided write command C_W1 and the address ADDR_TG where source data is to be stored.

During a time t4, data is directly being transmitted between the source memory device 100a and the target memory device 100c through the shared data pins, during which the data transmission may be performed without intervention of the memory controller. That is, a process of transmitting data outputted from the source memory device 100a to the memory controller and transmitting data outputted from the memory controller to the target memory device is omitted.

In order to transmit the data, the source memory device 100a and the target memory device 100c are simultaneously enabled during the time t4. However, since the activated mask signal MSK1a for masking the write enable signal WE is provided to the source memory device 100a, the source memory device 100a outputs data stored in an internal buffer circuit to the shared data pins, as the read enable signal RE toggles. Furthermore, since the activated mask signal MSK2c for masking the read enable signal RE is provided to the target memory device 100c, the target memory device 100c receives data through the shared data pins.

The write enable signal WE may be delayed by a predetermined time ΔD from the read enable signal RE such that data outputted from the source memory device 100a is stably provided to the target memory device 100c.

During a time t5, the data inputted to the target memory device 100c is programmed into memory cells of the target memory device 100c. For example, the command latch enable signal CLE and the write enable signal WE are activated to provide a write command C_W2 to the memory device. Although the control signals are shared by the memory devices 100a, 100b, and 100c through the connection among the control signal pins, only the memory device 100c may receive the command, because activated mask signals for masking the write enable signal (FIG. 6 shows the mask signal MSK1a) are provided to the respective memory devices 100a and 100b. The target memory device 100c programs the input data into the memory is cells according to the provided write command C_W2.

The data transmission method of the memory devices sharing the chip enable signal CE, that is, the memory devices 100a, 100b, and 100c of FIG. 1, has been described with reference to FIGS. 5 and 6. The data transmission method of the memory devices to which the chip enable signal CE is individually applied, that is, the memory devices 200a, 200b, and 200c may be performed in a substantially similar manner, except for the process of individually applying the chip enable signal CE to set the source memory device and the target memory device (t1 and t3).

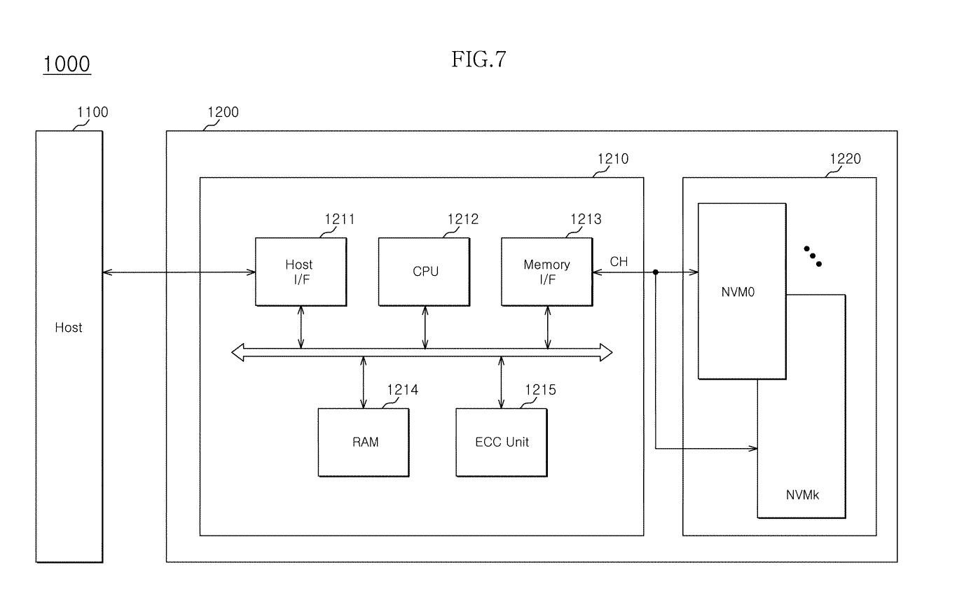

FIG. 7 is a block diagram illustrating a data processing system including the nonvolatile memory device according to an embodiment of the present invention. Referring to FIG. 7, the data processing system 1000 includes a host 1100 and a data storage device 1200. The data storage device 1200 includes a controller 1210 and a data storage medium 1220. The data storage device 1200 may be connected to the host 1100 such as a desktop computer, a notebook computer, a digital camera, a mobile phone, an MP3 player, a game machine or the like. The data storage device 1200 is also referred to as a memory system.

The controller 1210 is coupled to the host 1100 and the data storage medium 1220. The controller 1210 is configured to access the data storage medium 1220 in response to a request from the host 1100. For example, the controller 1210 is configured to control a read, program, or erase operation of the data storage medium 1220. The controller 1210 is configured to drive firmware for controlling the data storage medium 1220.

The controller 1210 may include well-known components such as a host interface 1211, a central processing unit (CPU) 1212, a memory interface 1213, a RAM 1214, and an error correction code (ECC) unit 1215.

The CPU 1212 is configured to control overall operations of the controller 1210 in response to a request by the host. The RAM 1214 may be used as a working memory of the CPU 1212. The RAM 1214 may temporarily store data read from the data storage medium 1220 or data provided from the host 1100.

The host interface 1211 is configured to interface the host 1100 and the controller 1210. For example, the host interface 1211 may be configured to communicate with the host 1100 through one of a USB (Universal Serial Bus) protocol, an MMC (Multimedia Card) protocol, a PCI (Peripheral Component Interconnection) protocol, a PCI-E (PCI-Express) protocol, a PATA (Parallel Advanced Technology Attachment) protocol, a SATA (Serial ATA) protocol, an SCSI (Small Computer System Interface) protocol, and an IDE (Integrated Drive Electronics) protocol.

The memory interface 1213 is configured to interface the controller 1210 with the data storage medium 1220. The memory interface 1213 is configured to provide a command and address to the data storage medium 1220. Furthermore, the memory interface 1213 is configured to exchange data with the data storage medium 1220.

The ECC unit 1215 is configured to detect an error of the data read from the data storage medium 1220. Further, the ECC unit 1215 is configured to correct the detected error, when the detected error falls within a correction range. The ECC unit 1215 may be provided externally or internally with respect to the controller 1210 depending on the memory system 1000.

The data storage medium 1220 may include a plurality of nonvolatile memory devices NVM0 to NVMk. The nonvolatile memory devices NVM0 to NVMk may be connected to each other so as to share control signals and data, as illustrated in FIGS. 1 and 3. Therefore, the nonvolatile memory devices NVM0 to NVMk may directly exchange data without intervention of the controller.

The controller 1210 and the data storage medium 1220 may be integrated to form a solid state drive (SSD).

As another example, the controller 1210 and the data storage medium 1220 may be integrated into one semiconductor device to form a memory card. For example, the controller 1210 and the data storage medium 1220 may be integrated into one semiconductor device to form a PCMCIA (personal computer memory card international association) card, a CF (compact flash) card, a smart media card, a memory stick, a multi-media card (MMC, RS-MMC, or MMC-micro), an SD (secure digital) card (SD, Mini-SD, or Micro-SD), or a UFS (universal flash storage) card.

As another example, the controller 1210 or the data storage is medium 1220 may be mounted in various types of packages. The controller 1210 or the data storage medium 1220 may be packaged and mounted according to various methods such as package on package (POP), ball grid arrays (BGAs), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat package (MQFP), thin quad flat package (TQFP), small outline IC (SOIC), shrink small outline package (SSOP), thin small outline package (TSOP), thin quad flat package (TQFP), system in package (SIP), multi chip package (MCP), wafer-level fabricated package (WFP), and wafer-level processed stack package (WSP).

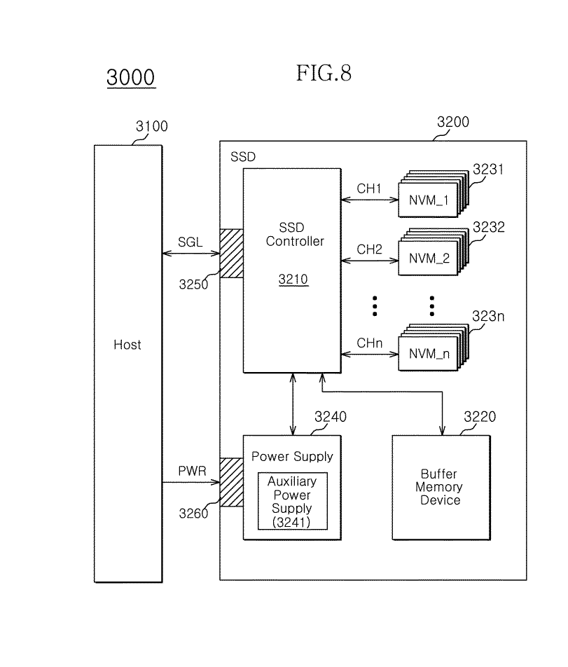

FIG. 8 is a block diagram illustrating an SSD configured to perform the data transmission method according to an embodiment of the present invention. Referring to FIG. 8, a data processing system 3000 includes a host 3100 and an SSD 3200.

The SSD 3200 includes an SSD controller 3210, a buffer memory device 3220, a plurality of nonvolatile memory devices 3231 to 323n, a power supply 3240, a signal connector 3250, and a power connector 3260.

The SSD 3200 operates in response to a request by the host device 3100. That is, the SSD controller 3210 is configured to access the nonvolatile memory devices 3231 to 323n in response to a request from the host 3100. For example, the SSD controller 3210 is configured to control read, program, and erase operations of the nonvolatile memory devices 3231 to 323n.

The buffer memory device 3220 is configured to temporarily store data which are to be stored in the nonvolatile memory devices 3231 to 323n. Further, the buffer memory device 3220 is configured to temporarily store data read from the nonvolatile memory devices 3231 to 323n. The data temporarily stored in the buffer memory device 3220 are transmitted to the host 3100 or the nonvolatile memory devices 3231 to 323n, according to the control of the SSD controller 3210.

The nonvolatile memory devices 3231 to 323n may be used as storage media of the SSD 3200. The nonvolatile memory devices 3231 to 323n are connected to the SSD controller 3210 through a plurality of channels CH1 to CHn, respectively. One channel may be connected to one or more nonvolatile memory devices. The nonvolatile memory devices connected to one channel may be connected to the same signal bus and data bus. That is, the nonvolatile memory devices connected to one channel may be connected to each other so as to share control signals and data, as illustrated in FIGS. 1 and 3. Therefore, the memory devices connected to one channel may directly exchange data without intervention of the SSD controller 3210.

The power supply 3240 is configured to provide power PWR inputted through the power connector 3260 into the SSD 3200. The power supply 3240 includes an auxiliary power supply 3241. The auxiliary power supply 3241 is configured to supply power to normally terminate the SSD 3200, when power suddenly shuts off. The auxiliary power supply 3241 may include super capacitors capable of storing the power PWR.

The SSD controller 3210 is configured to exchange signals SGL with the host 3100 through the signal connector 3250. Here, the signals SGL may include commands, addresses, data and the like. The signal connector 3250 may include a connector such as PATA (Parallel Advanced Technology Attachment), SATA (Serial Advanced Technology Attachment), SCSI (Small Computer System Interface), or SAS (Serial SCSI), according to the interface method between the host 3100 and the SSD 3200.

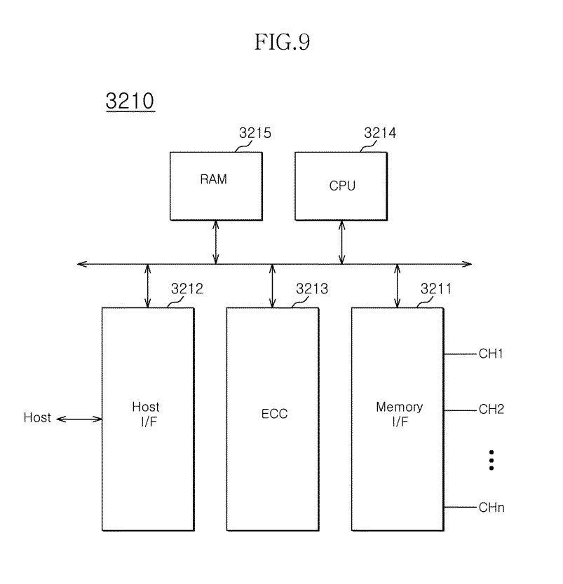

FIG. 9 is a block diagram illustrating the SSD controller of FIG. 8. Referring to FIG. 9, the SSD controller 3210 includes a memory interface 3211, a host interface 3212, an ECC unit 3213, a CPU 3214, and a RAM 3215.

The memory interface 3211 is configured to provide a command and address to the nonvolatile memory devices 3231 to 323n. Further, the memory interface 3211 is configured to exchange data with the nonvolatile memory devices 3231 to 323n. The memory interface 3211 may scatter data transmitted from the buffer memory device 3220 over the respective channels CH1 to CHn, according to the control of the CPU 3214. Further, the memory interface 3211 transmits data read from the nonvolatile memory devices 3231 to 323n to the buffer memory device 3220, according to the control of the CPU 3214.

The host interface 3212 is configured to provide an interface with the SSD 3200 in response to the protocol of the host 3100. For example, the host interface 3212 may be configured to communicate with the host 3100 through one of PATA (Parallel Advanced Technology Attachment), SATA (Serial Advanced Technology Attachment), SCSI (Small Computer System Interface), SAS (Serial SCSI) protocols. Further, the host interface 3212 may perform a disk emulation function of supporting the host 3100 to recognize the SSD 3200 as a hard disk drive (HDD).

The ECC unit 3213 is configured to generate parity bits based on the data transmitted to the nonvolatile memory devices 3231 to 323n. The generated parity bits may be stored in spare areas of the nonvolatile memory devices 3231 to 323n. The ECC unit 3213 is configured to detect an error of data read from the nonvolatile memory devices 3231 to 323n. When the detected error falls within a correction range, the ECC unit 3213 may correct the detected error.

The CPU 3214 is configured to analyze and process a signal SGL inputted from the host 3100. The CPU 3214 controls overall operations of the SSD controller 3210 in response to a request by the host 3100. The CPU 3214 controls the operations of the buffer memory device 3220 and the nonvolatile memory devices 3231 to 323n according to firmware for driving the SSD 3200. The RAM 3215 is used as a working memory device for driving the firmware.

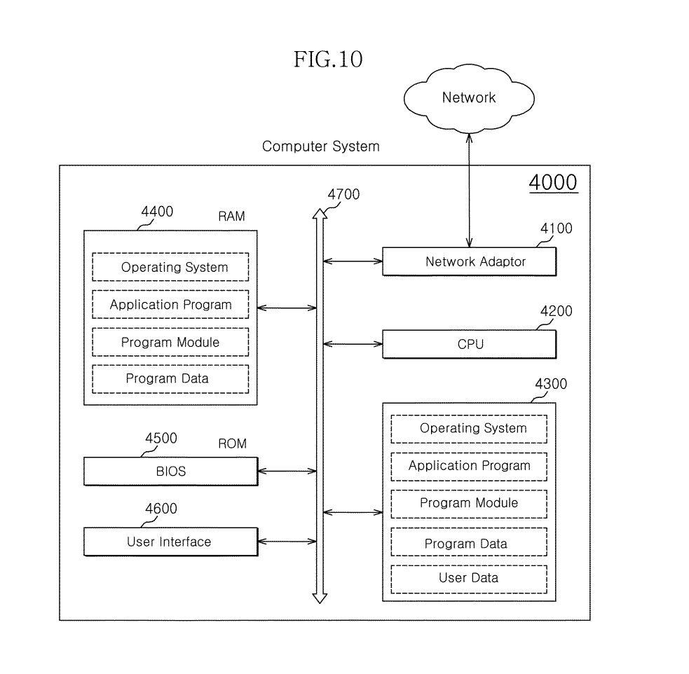

FIG. 10 is a block diagram illustrating a computer system in which the data storage device according to an embodiment of the present invention is mounted. Referring to FIG. 10, the computer system 4000 includes a network adapter 4100, a CPU 4200, a data storage device 4300, a RAM 4400, a ROM 4500, and a user interface 4600, which are electrically connected to the system bus 4700. Here, the data storage device 4300 may include the data storage device 1200 illustrated in FIG. 7 or the SSD 3200 illustrated in FIG. 8.

The network adapter 4100 is configured to provide an interface between the computer system 4000 and external networks. The CPU 4200 is configured to perform overall arithmetic operations for driving an operating system or application programs contained in the RAM 4400.

The data storage device 4300 is configured to store overall data required by the computer system 4000. For example, the operating system for driving the computer system 4000, application programs, various program modules, program data, and user data may be stored in the data storage device 4300.

The RAM 4400 may be used as a working memory device of the computer system 4000. During booting, the operating system, application programs, various program modules, which are read from the data storage device 4300, and program data required for driving the programs are loaded into the RAM 4400. The ROM 4500 stores a basic input/output system (BIOS) which is enabled before the operating system is driven. Through the user interface 4600, information exchange is performed between the computer system 4000 and a user.

Although not illustrated in the drawing, the computer system 4000 may further include a battery, application chipsets, a camera image processor (CIP) and the like.

According to embodiments of the present invention, since data may be directly transmitted between the memory devices, the operating speed of the data storage device may be increased.

While certain embodiments have been described above, it will be understood to those skilled in the art that the embodiments described are by way of example only. Accordingly, the data storage device described herein should not be limited based on the described embodiments. Rather, the data storage device described herein should only be limited in light of the claims that follow when taken in conjunction with the above description and accompanying drawings.

What is claimed is:

1. A data storage device comprising:
a first memory device;
a second memory device configured to share a write control signal and a read control signal which are provided to the first memory device; and
a controller configured to control the first and second memory devices,
wherein the controller provides the write control signal and the read control signal to the first and second memory devices at the same time,
the first memory device receives only the read control signal according to a first mask signal, and
the second memory device receives only the write control signal according to a second mask signal.

2. The data storage device according to claim 1, wherein the first memory device is set to a source memory device according to the read control signal, and the second memory device is set to a target memory device to store data provided from the first memory device according to the write control signal.

3. The data storage device according to claim 2, wherein a plurality of data input/output pins of the first and second memory devices are connected to each other, and
wherein the first and second memory devices directly transmit data through the plurality of data input/output pins.

4. The data storage device according to claim 3, wherein data outputted from the first memory device is transmitted to the second memory device without usage of the controller.

5. The data storage device according to claim 2, wherein the first memory device and the second memory device are enabled at the same time.

6. The data storage device according to claim 1, further comprising a third memory device configured to share the write control signal and the read control signal which are provided to the first and second memory devices,
wherein the third memory device does not receive both of the write control signal and the read control signal according to a third mask signal.

7. The data storage device according to claim 6, wherein the first, second, and third memory devices may receive a command and an address as well as data through the plurality of data input/output pins.

8. The data storage device according to claim 1, wherein the controller provides a third mask signal to the first memory device so as to control the first memory device to receive only the write control signal, and provides a fourth mask signal to the second memory device so as to control the second memory device to receive only the read control signal.

9. The data storage device according to claim 1, wherein the first and second memory devices comprise a NAND flash memory device.

10. The data storage device according to claim 1, wherein the first and second memory device and the controller comprise a solid state drive (SSD).

11. The data storage device according to claim 1, wherein the first and second memory device and the controller comprise a memory card.

12. The data storage device according to claim 1, wherein the first and second memory device and the controller may be mounted in various types of packages.

13. An operating method of a data storage device including a plurality of memory devices, comprising the steps of:
applying a write control signal and a read control signal to both a first memory device and a second memory device at the same time;
applying a first mask signal to the first memory device so as to control the first memory device to receive only the read control signal;
applying a second mask signal to the second memory device so as to control the second memory device to receive only the write control signal; and
controlling the first and second memory devices at the same time such that the first memory device outputs data while the first mask signal is applied and the second memory device receives data outputted from the first memory device while the second mask signal is applied.

14. The operating method according to claim 13, wherein the data outputted from the first memory device is directly transmitted to the second memory device without usage of a controller for controlling the first and second memory devices.

15. The operating method according to claim 13, further comprising the steps of:
applying a third mask signal to the first memory device so as to control the first memory device to receive only the write control signal; and
applying a fourth mask signal to the second memory device so as to control the second memory device to receive only the read control signal.

16. The operating method according to claim 15, wherein the first memory device performs a read operation while the third mask signal is applied.

17. The operating method according to claim 15, wherein the second memory device performs a write operation while the second mask signal is applied.

18. The operating method according to claim 13, further comprising the step of applying a fifth mask signal to a third memory device so as to control the third memory device to not receive both the write control signal and the read control signal.
